(19) United States
(12) Patent Application Publication
(10) Pub. No.: US 2020/0250778 A1
(43) Pub. Date: Aug. 6, 2020

(54) System and Method for Managing Patent Risk

(71) Applicants: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(72) Inventors: ERICH LAWSON SPANGENBERG, PARIS (FR); DANIEL LAWRENCE BORK, EAST KINGSTON, NH (US); PASCAL ASSELOT, PARIS (FR); BRIAN JOSHUA BERMAN, LONG ISLAND CITY, NY (US)

(21) Appl. No.: 16/758,384

(22) PCT Filed: Oct. 22, 2018
(86) PCT No.: PCT/US18/56884

§ 371 Date: Apr. 22, 2020

Related U.S. Application Data
(63) Continuation-in-part of application No. 16/758,375.
(60) Provisional application No. 62/576,516, filed on Oct. 24, 2017.
(60) Provisional application No. 62/575,610, filed on Oct. 23, 2017.
(60) Provisional application No. 62/577,253, filed on Oct. 26, 2017.
(60) Provisional application No. 62/579,172, filed on Oct. 31, 2017.
(60) Provisional application No. 62/579,347, filed on Oct. 31, 2017.
(60) Provisional application No. 62/582,976, filed on Nov. 8, 2017.
(60) Provisional application No. 62/588,350, filed on Nov. 19, 2017.
(60) Provisional application No. 62/588,932, filed on Nov. 21, 2017.
(60) Provisional application No. 62/607,919, filed on Dec. 20, 2017.
(60) Provisional application No. 62/610,265, filed on Dec. 25, 2017.
(60) Provisional application No. 62/622,922, filed on Jan. 28, 2018.
(60) Provisional application No. 62/622,987, filed on Jan. 29, 2018.
(60) Provisional application No. 62/622,994, filed on Jan. 29, 2018.
(60) Provisional application No. 62/660,946, filed on Apr. 21, 2018.
(60) Provisional application No. 62/672,697, filed on May 17, 2018.
(60) Provisional application No. 62/685,299, filed on Jun. 15, 2018.
(60) Provisional application No. 62/685,937, filed on Jun. 16, 2018.
(60) Provisional application No. 62/685,960, filed on Jun. 16, 2018.
(60) Provisional application No. 62/689,241, filed on Jun. 24, 2018.
(60) Provisional application No. 62/695,002, filed on Jul. 7, 2018.
(60) Provisional application No. 62/695,126, filed on Jul. 8, 2018.
(60) Provisional application No. 62/696,357, filed on Jul. 11, 2018.

(51) Int. Cl. G06Q 50/18; G06Q 40/08; H04L 9/08

(52) U.S. Cl. CPC G06Q 50/184; G06Q 40/08; H04L 2209/56; H04L 2209/38; H04L 9/0825

(57) ABSTRACT

The invention is a patent risk management system, to control patent prosecution costs. There will be different kinds of patent insurance: 1. Patent application insurance and 2. Patent Issuance Insurance. The amount of the fee paid by Applicant is not fixed. This amount is flexible, based on how much insurance protection the Applicant wants. Also, if important parts of the invention are in the claims (and this claim language remains in the issued patent), then the Applicant can pay a reduced risk management insurance

### PRIORITY CLAIMS

This application claims the benefit of U.S. Provisional Patent Application No. 62/576,516, filed Oct. 24, 2017. This application also claims the benefit of International Patent Appl. No. PCT/US2018/56690, filed on Oct. 19, 2018, which claims the benefit of U.S. Provisional Patent Application No. 62/575,610, filed Oct. 23, 2017. This application also claims the benefit of U.S. Provisional Patent Application No. 62/577,253, filed Oct. 26, 2017. This application also claims the benefit of U.S. Provisional Patent Application No. 62/579,172, filed Oct. 31, 2017. This application also claims the benefit of U.S. Provisional Patent Application No. 62/579,347, filed Oct. 31, 2017. This application also claims the benefit of U.S. Provisional Patent Application No. 62/582,976, filed Nov. 8, 2017. This application also claims the benefit of U.S. Provisional Patent Application No. 62/588,350, filed Nov. 19, 2017. This application also claims the benefit of U.S. Provisional Patent Application No. 62/588,932, filed Nov. 21, 2017. This application also claims the benefit of U.S. Provisional Patent Application No. 62/607,919, filed Dec. 20, 2017. This application also claims the benefit of U.S. Provisional Patent Application No. 62/610,265, filed Dec. 25, 2017. This application also claims the benefit of U.S. Provisional Patent Application No. 62/622,922, filed Jan. 28, 2018. This application also claims the benefit of U.S. Provisional Patent Application No. 62/622,987, filed Jan. 29, 2018. This application also claims the benefit of U.S. Provisional Patent Application No. 62/622,994, filed Jan. 29, 2018. This application also claims the benefit of U.S. Provisional Patent Application No. 62/660,946, filed Apr. 21, 2018. This application also claims the benefit of U.S. Provisional Patent Application No. 62/672,697, filed May 17, 2018. This application also claims the benefit of U.S. Provisional Patent Application No. 62/685,299, filed Jun. 15, 2018. This application also claims the benefit of U.S. Provisional Patent Application No. 62/685,937, filed Jun. 16, 2018. This application also claims the benefit of U.S. Provisional Patent Application No. 62/685,960, filed Jun. 16, 2018. This application also claims the benefit of U.S. Provisional Patent Application No. 62/689,241, filed Jun. 24, 2018. This application also claims the benefit of U.S. Provisional Patent Application No. 62/695,002, filed Jul. 7, 2018. This application also claims the benefit of U.S. Provisional Patent Application No. 62/695,126, filed Jul. 8, 2018. This application also claims the benefit of U.S. Provisional Patent Application No. 62/696,357, filed Jul. 11, 2018, each of which is incorporated herein by reference.

### BACKGROUND

Patents are a vitally important form an intellectual property. Their importance is outlined by the fact the USPTO granted 320,000 patents in 2017 alone. However, one major issue associated with patents relates to the costs and risks associated with prosecuting, maintaining, and defending patent protection. The introduction of blockchain technology and smart contracts however, may play a critical role in unlocking a cost effective method of mitigating patent risk.

With specific reference to patents, historians trace the roots of the patent system back 600 years before the Common Erainitially granting the creators of new recipes exclusive rights to the recipes they developed and disclosed.¹ The first industrial patents were granted by kings in the 1400's and the first patent laws were developed by the Venetians and enacted in the late 1400's.² The conceptual societal bargain underpinning patents is very simple: the inventor of something new makes a public disclosure of that innovation and in exchange is given exclusive rights, to that innovation for a limited period of time. Stated otherwise, the holder of the patent is given a time limited monopoly related to that invention. Accordingly, the Patent system was intended to promote innovation. ¹ [“Six significant moments in patent history,” https://www.reuters.com/article/us-moments-patent/six-significant-moments-in-patent-history-idUSKBN0IN1Y120141104, 2014.]² Same.

Over time, the concept of patents has evolved globally and become critical in the development of innovation, jobs and prosperity.³ For example, in the United States, the framers of the Constitution felt that patents were so critical to the development of the economy that they provided a specific provision for patents in Article I of the US Constitution. In China, the first patent laws were not adopted until 1984, yet today, China leads the world in the annual number of patent applications filed. In fact, in the last 30 years China has become one of the leading forces in the patent market. Emerging and developing countries are making notable efforts to promote patents and are investing in the development of patent systems to promote prosperity. Most major developed countries have a specific patent system. ³ https://www.brookings.edu/wp-content/uploads/2016/06/patenting-prosperity-rothwell.pdf

Within the current patent ecosystem patents fall under a corporate asset class known as Intangibles. Today, US companies are worth about $14.5 trillion in Intangibles alone.⁴ Global research and development expenditure on intangibles is $1.9 trillion USD, and generally closely tracks patent filings and grants.⁵ In fact in 1975, the S&P 500 market value of intangible assets was 17%. In 2015, the S&P 500 market value of intangible assets grew to 87%.⁶ This change to a knowledge economy makes patents even more important. ⁴ “Annual licensing and royally revenues now total $180 billion, says new WIPO report,” http://www.iam-media.com/blog/detail.aspx?g=acd471cb-956d-4103-bb63-ac75d04fc068, 2011.⁵ “2016 Global R&D Funding Forecast,” https://www.iriweb.org/sites/default/files/2016GlobalR%26DFundingForecast_2.pdf, 2016.⁶ “Annual Study of Intangible Asset Market Value from Ocean Tomo, LLC,” http://www.oceantomo.com/2015/03/04/2015-intangible-asset-market-value-study/, 2015.

Despite the growing tend towards obtaining various Intellectual property, including patents, a major issue within the patent ecosystem relates to the costs associated with acquiring, maintaining, and defending the same. Inventors are faced with a scenario wherein they must first expend significant amounts of time and resources towards obtaining patent protection in order to profitably practice an invention. This proposition itself is risky since the governing authorities in charge of providing protection determine patentability after significant resources are expended.

Moreover, even if an inventor is able to obtain protection, they must then actively seek to prevent infringes. This is particularly daunting since the most common tactics defending against any litigation begin with scrutinizing the patent in a review process.

Moreover, NPEs with large portfolios often use competing patents to argue “prior art.” Thus, the inventor seeking to protect his position must once again expend significant resources defending that his position that the patent grant provided by a regulatory authority was appropriate in the first place. Finally, even if the patent holds up to a challenge, litigations are often lengthy and may result in a court award that invalidates a patent despite significant resources being expended.

These risks have presented a significant drawback to the Patent field. Inventors are left wondering whether the patent is really worth the trouble. Many are simply abandoning challenged patents to avoid the costs. Many are even considering not obtaining patent protection at all. The current invention seeks to provide an improved risk management system associated with patenting.

### SUMMARY OF INVENTION

Currently, it costs an inventor or company around $100,000 to file and prosecute a global patent from application to grant. This includes legal fees and various government fees. In addition, the inventor himself must dedicate a significant amount of time working on the patent application. This necessarily results in additional lost value where the inventor was focused on the patent rather than the progress of the invention. As such, the cost associated with obtaining a patent can be significant.

Despite spending significant sums of money and time, inventors are faced with the harsh reality that their application may not be granted. This is especially troubling in light of the fact of the sheer number of ways a patent can be attacked: During prosecution, during review in front of a regulatory authority, or through litigation by courts. This has added a risk element associated with applying for patents.

Litigation itself has further propounded the issue. Every year, thousands of companies collectively spend more than $10 billion fighting and settling lawsuits brought by patent trolls, also known as non-practicing entities or NPEs. In 2015, the total number of defendants added to NPE suits rose 22% to more than 4,100. Moreover, patent trolls don't limit their attacks to technology makers. Their model is based on demanding payment from any company that they believe is infringing a patent, and the patented technology in question can be in any product your company makes, sells or simply uses in the normal course of business.⁷ ⁷ “Reducing Exposure to Patent Trolls,” http://www.rmmagazine.com/2016/05/02/reducing-exposure-to-patent-trolls/, 2016.

Fighting back has not solved the problem since the cost of litigation results in more than 90% of NPE-initiated litigations settling before judgment. More importantly the defendant ultimately agrees to pay for a license. “Fighting hard” does not result in a better price and does not dissuade trolls from attacking again in the future. In short, fighting NPE litigation only wastes time (litigations typically last at least 12 months and often take years to resolve) and money (legal fees alone can easily reach six figures and settlement amounts are often inflated by the litigation process). Hence, many inventors are taking the approach that the most logical way to reduce NPE risk is to shift your approach from reacting to an attack to preempting the source of the risk.

The current solutions to patent risk management revolve around patent litigation insurance. Today there are various flavors of patent litigation insurance. For smaller or emerging businesses that are only starting to experience regular patent assertions by trolls, insurance is an effective way to transfer a potentially high-cost risk that could be damaging or even fatal. For more established companies that are successfully managing their NPE risk with proactive tools, liability insurance adds a critical safety net by reducing exposure to risk if they face a spike in the number of patent attacks or if those attacks turn out to be unexpectedly expensive. While relatively rare, trolls have won large awards and settlements in the tens and even hundreds of millions of dollars.

However, there are significant problems associated with the current solutions in the Patent Risk Management field. First, many of the Patent Risk Management companies are invite only. They only allow top, big companies to participate in their defensive patent aggregation funds, risk management, or insurance funds. For example, RPX and Allied Security Trust (AST) only allow big companies to participate in their patent risk management funds.

A second problem is that many of the current patent insurance companies require significant monthly or annual fee. Subsequently, the patent insurance company makes all of the decisions on behalf of the members. Therefore, the individual members typically lose decision making authority, power, or control over their patent applications.

Sadly, recent trends argue that the only reasonable way for countering the threat these threats is to recognize that the heart of the issue is the patent. Companies are tending to take the approach: Remove the patent and you remove the risk of being sued for infringing it. In fact, above referenced article even went on to argue that:

“there is no viable tactic to make NPEs disappear. There are hundreds of active trolls and they have billions of dollars to buy patents to assert. There are, however, ways to eliminate risky patents. This may seem counterintuitive at first. Most general counsel and risk managers assume that the only prudent response to being sued is to mount a legal defense. But history has shown that this is actually the least efficient and least effective way to react.”

Through the use blockchain technology, the present invention seeks to disclose a decentralized platform that provides a cost effective and improved method of evaluating and managing patent risk.

Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

Blockchain is a relatively new technology. The first “real world” implementations of Blockchain, Bitcoin, envisioned by Satoshi Nakamoto launched in 2009. The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.⁸ ⁸. “Ethereum Whitepaper,” http://github.com/ethercum/wiki/wiki/white-paper, 2016

Blockchain data transfer is currently considered one the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

The Bitcoin blockchain is limited to sets of simple information and scripts such as transaction details, and conditioning a transaction on a minimum number of signatories. It was therefore argued that for a virtual currency to truly revolutionize trade it must also provide built-in means for facilitating complex contracts and deals with the currency.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality.

Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available.

This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup.

It should be mentioned that after Ethereum, several other virtual currency networks implementing smart contracts were established. Prominent examples include the IBM Hyperledger, Lisk and RootStock.

### BRIEF DESCRIPTION OF THE DRAWINGS

The various embodiments are illustrated by way of example, and not by way of limitation, in the figures of the accompanying drawings in which:

FIG. 1 depicts an illustration of the methodology of the present invention.

FIG. 2 depicts an illustration of the methodology of the present invention.

### DETAILED DESCRIPTION OF INVENTION

The proposed invention seeks to distributed blockchain allow worldwide participation in the registration and tracking process. Through the use of data analytics the network seeks to implement a system that can provide custom patent risk management insurance and strategies to inventors that cover various phases of the patenting process from application all the way to litigation.

This decentralized network will require at least one server, a processor, and at least one networking interface (“Network” or “IPWe Platform” or “IPWe”). Such a Network will allow the connection of user devices through the Internet. The Network itself will consist of at least one server, which will host a webpage, that when executed, will allow users to access a portal and be identified cryptographically using a private key and public key. The web portal or other network connected device will provide a platform to connect a patent owner with other stakeholders in the patent process.

In order for a decentralized system to function, one embodiment of the present invention envisions a patent mitigation insurance ecosystem functioning on a blockchain network.

In one embodiment of the present invention, the decentralized network is a blockchain network. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems to provide a pooled resource for Patent owners and other stake holders.

A computer, network, or blockchain, may deploy a smart contract. A smart contract is computer code that implements transactions of a contract. The computer code may be executed in a secure platform (e.g., an Ethereum platform, IBM Hyperledger platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account, transfer the ownership of a patent). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct amount of tokens to and from the correct accounts.

The blockchain network may include multiple computers, networks, links, and databases. Miners may manage the blockchain, whereas the managing may include, for example, validating a smart contract and/or transaction according to the smart contract, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract.

The smart contract may determine the rules for evaluating a token price and an initial status of the token (such as the reserve of the token) and any other rules that should be applied during a transaction.

The platform itself can construct a smart contract in real time based on inputs from an inventor or patent holder. In one embodiment, the inventor submits the patent application, and the network uses an analysis engine to generate a report regarding the likelihood of patentability based on several criteria, including patentable nature of the invention, the status of prior art, and the novelty of the inventive step. The platform further provides a user to express interest in insurance, and provides a rate and insurance premium price using FIAT currency and virtual currency. The user can select the options that seem most beneficial to the user at that time.

One issue with the current patent mitigation ecosystem is that it provides insurance for limited reasons. In one embodiment, the current invention provides customizable insurance tailored for patents, including a claims management portion which focuses on minimizing exposure to patent litigation damages. The purpose of patent risk management is to control patent prosecution costs. Additional options will include Patent application insurance in order to cover for the potential of rejection, and Patent Issuance Insurance in order to cover costs associated with patent challenges post grant.

In one embodiment of the present invention, before a patent issues, an inventor/Applicant can pay an amount (such as a fixed amount, but not limited to a fixed amount), such as $2,500 or $5,000 during the prosecution of a patent application, for patent application insurance. If the eventual patent is invalidated in the future, then the inventor/Applicant would receive a certain amount (such as a fixed amount, but not limited to a fixed amount), such as $150,000.

In one embodiment of the present invention, after a patent issues, a Patent Owner can pay an amount (such as a fixed amount, but not limited to a fixed amount), such as $5,000 for patent issuance insurance. If the patent is invalidated in the future, then the inventor/Applicant would receive a certain amount (such as a fixed amount, but not limited to a fixed amount), such as $150,000.

Data analytics of blockchain transactions will play central role in issuing insurance. Since the blockchain ledger is public, much of the transactional data can be verified and analyzed. In one embodiment, the internal analytics tool “Zuse Analyitcs” is a platform connected tool that can search various sources for patent data. Using historical evidence, the Zuse Analyitcs engine can provide information regarding important or relevant sections of a patent that can prevent or challenge patentability.

In another embodiment, Zuse Analytics can provide information regarding heart of the invention. Therefore, if a patent is issued/granted on this highlighted text (that is, the patent claims cover this highlighted text identified by Zuse Analytics).

In another embodiment, the platform can customize an insurance plan and rates based on the historical Zuse analysis. As an exemplar, if the Zuse Analysis determines that a specific portion of the patent contains an inventive step that is previously not available, the insurance rate can be adjusted to account for the same.

Typically, patent management insurance can be hard to quantify due to the lack of knowledge regarding future decisions. In one embodiment, the Zuse Analysis data is used to determine the likelihood that a patent or portion of a patent is likely to survive patent validity challenge. The analysis may be further based on historical information and the likelihood that the inventive concept of the patent application is more likely to turn/mature into an issued patent, as opposed to other parts of the patent application.

The platform can further provide customized rates and patent management based on prior art. Using Zuse Analysis the specification can be compared to various other specifications and claims available for review. The platform can predict and offer an insurance rate based on criteria including the number of patents containing similar text, the amount of matching text, the fields of compared applications and specifications, the litigious nature of an entity or inventor to name a few.

In another embodiment, the platform can determine the eligibility for insurance and determine fees based solely on specific criterion such as patentability, prior art, obviousness, and other qualities.

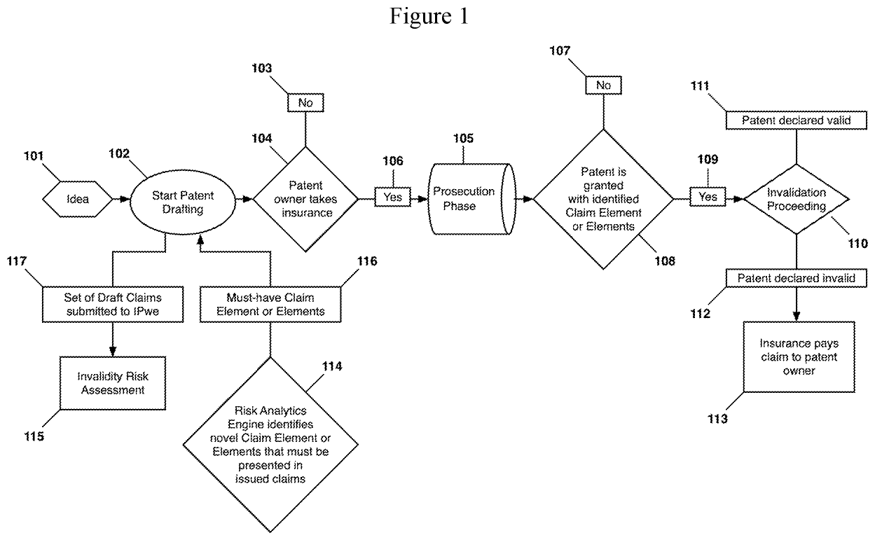

FIG. 1, which depicts a flow diagram of one embodiment of the present invention illustrates the process by which the network can deploy patent mitigation insurance. An idea 101 moves towards the drafting phase when an inventor starts patent drafting 102. At that juncture the inventor would submit a set of draft claims to the Network 117. The Network would utilize internal analysis software to produce an invalidity risk assessment 115. The Risk analysis engine would identify novel claim elements or necessary elements that must be present in issued patents 114. The must have claim elements are identified 116 and incorporated into the patent draft 102. Claims applicant is then provided an option to take a risk mitigation insurance policy 104. The inventor can choose not to take the policy 103 or to purchase the policy 106 which would then move the invention into the drafting and prosecution phase 105. The appropriate regulatory authority reviews the application with the identified claimed elements 108 determines whether the patent is granted 109 or not 107. After grant 109, should the patent face an invalidation proceeding 110 and is declared invalid 112 the insurance policy is paid to the owner purchaser 113. Otherwise, the patent is declared valid 111.

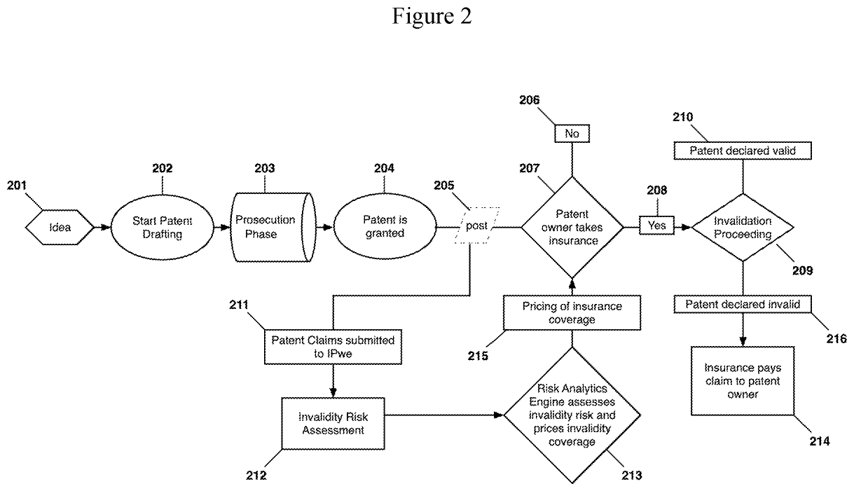

FIG. 2, which depicts a flow diagram of another embodiment of the present invention illustrates the process by which the network can deploy patent mitigation insurance. An idea 201 is incorporated into a patent draft 202 and enters the prosecution phase 203. A regulatory authority grants the patent 204. Post 205 grant, the claims are submitted to the network 211. The network using conducts a risk assessment 212 and the risk analysis engine asses invalidity risk and prices coverage 213. The pricing of the insurance coverage is presented to the patent owner 215 who decides 207 to take the insurance 208 or not 206. Should the patent face an invalidation proceeding 209 it may be declared valid 210 or invalid 216. An invalid patent that was insured would be paid out of the insurance policy 214.

In one embodiment the network provides an insurance holder the ability to file a claim, to monitor the status of a patent claim, and to collect the appropriate recovery based on the reasons for rejection, cancellation, or invalidity.

In one embodiment, the network can determine and offer a participating inventor or entity separate insurance rates and policy limits based on data obtained from other interactions regarding the likelihood of rejection for specific criteria such as invalidity, patentability, obviousness, and prior art to name a few.

In another embodiment, the platform can offer different insurance rates, policy limits, and policy payouts based on the status of a rejection, namely if the patent is invalidated completely or partially. The patent platform can analyze the number of claims invalidated, the relation to the specification and the similarity of the remaining claims and specification to prior art. Offerings can be adjusted based on the same.

In one embodiment, if a 75% of the independent and dependent claims are invalidated, the potential limit of a policy may such that it is be reduced by the same 75%.

In one embodiment, a blockchain patent risk management solution allow anyone worldwide to more quickly and efficiently register and join a patent risk management solution. Also, the individual member could customize the insurance program. The platform may allow an individual member to customize a unique insurance program, separate for only that one individual member. That member could allow other parties to join that unique customized insurance program.

In another embodiment the blockchain patent risk management system could be utilized by a greater range of individuals, and thereby reduce patent mitigation insurance fees.

In one embodiment, the platform can provide the option of allowing payment of fees through alternative fee arrangements, instead of how many current insurance providers simply charge monthly or annual membership fees. The alternative fee arrangements could include paying a success fee based on if the patent is invalidated.

In one embodiment, the platform can provide patent applicants to offer their invention for review to a connected community. Members of the public may be invited to submit prior art and analysis to determine the inventive step or validity of a patent application.

In another embodiment, the platform will further provide an option to crowdfund patent applications based on Zuse Analysis. The platform may record ownership information, identification information, and provide a detailed analysis of the likelihood that a patent will withstand the various attacks to a potential investor.

In another embodiment, the crowdfunding options can further include a syndicate or pool of multiple patents. Analysis of the likelihood of patentability or the chances that a patent will withstand a challenge can based on historical data, inventor data, and crowd commentary.

Data analysis can play an important role in patent risk mitigation. In one embodiment of the present invention the data analysis engine is made up of a at least one processor, one computer readable memory, and is further configured to execute code. The code itself is configured to review publicly available information regarding patents. Where a user submits a set of claims or a specification, the data analysis engine searches all publicly known databases for related terms. The related terms are matched and any prior art is categorized for the user review.

In one embodiment the data analysis engine can further communicate with the decentralized network platform and increase or decrease the cost of the insurance policy premium or the insurance policy limit based on a variety of factors, including the number of matching key terms prior art, the amount of prior art, the category of the prior art, the litigious nature of prior art owners, the profitability of the patent, and the status of the use of the item.

In another embodiment the data analysis engine searches the blockchain network of patents for any similar patents and determines the policy limit and policy premium based on a rating regarding the likelihood of success in obtaining patentability, the profitability of similar prior art, and the quality of the prior art.

In another embodiment, the data analysis engine can further determine a rating for the likelihood of facing a challenge to the patent registration. The analysis engine can control the policy limit and policy rate premium based on a variety of factors including the litigious nature of prior art holders, the historical success of prior art in similar fields and differences in the inventive step between the existing application and the prior art.

In another embodiment, the analysis engine is programmed to determine the differences between prior art and a patent application and thereby determines the inventive step in a given application or grant.

In another embodiment, the platform can further provide the ability to crowdfund various copyright applications, trademark applications, all other legal areas, and any non-legal areas.

In another example, the platform can provide options for financing patents including patent-backed financing, wherein, financing for a project can be secured based on an analysis of the patentability, novelty, and likelihood of grant of patent applications, or the strength of a patent grant to withstand a challenge.

In another embodiment, the platform can provide royalty-based financing, wherein a portion of future royalties can be trade to potential investors who can finance the patenting process.

In another embodiment, the platform can provide options of litigation financing, including crowdfunding based on a strength analysis. This can include offers to give up future royalty awards or even percentage ownership in rights to the grant.

In another embodiment, any financing offers are accompanied by a report providing an analysis on the likelihood of success in patentability, challenges, and litigation.

In another embodiment, the network can provide options for Litigation financing can be used on the blockchain platform. Litigation financing can be used without using blockchain.

Litigation financing can have a crowdfunding (fractional ownership), in that anyone from the public can finance litigation cases, in return for a percentage of the lawsuit's monetary award. Alternatively, the person who funded the litigation can receive nonmonetary forms of compensation, in exchange for funding the litigation.

In one embodiment, the present invention contains a method of transactions wherein all fees, payments, policy limits, purchases, and services are transacted using virtual currency, or cryptocurrency. The Network can further reward various stakeholders for participation within the network using the same cryptocurrency tokens. Each token can be traded or transacted using various systems and converted to FIAT currency. Such a system is applicable as a blockchain network.

One issue with patent mitigation insurance is that it can be slow to provide payments to claimants. In one embodiment of the present invention, a smart contract is generated at the outset of obtaining insurance. The smart contract contains a set of rules that are executed so long as the patent owner retains control of the patent and pays the premium. That code can be configured to automatically release the policy limits of an insurance policy at the occurrence of a specific event, such as patent invalidity, patent application rejection, or patent cancellation. The policy can be provided in FIAT or virtual currency, and will automatically transfer upon execution of the requisite conditions.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger.

The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain the, decentralized transactions can take place.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using, at least in part, a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removable or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of” can finance litigation cases, in return for a percentage of the lawsuit's monetary award. Alternatively, the person who funded the litigation can receive nonmonetary forms of compensation, in exchange for funding the litigation.

What is claimed is:

1. A method for providing patent risk mitigation, the method comprising:
a distributed network, the network comprising:
a plurality of nodes, wherein each node in the plurality of nodes is configured to transact autonomously with at least two nodes in the plurality of nodes and configured to communicate with at least one server;
the at least one server, the at least one server comprising at least one hardware processor, a non-transitory machine-readable storage medium having an executable computer readable program code, the at least one hardware processor configured to execute the computer-readable program code;
the server, capable of identifying at least one user using a private key and a public key and connected to an at least one user device;
the user device capable of communicating with the plurality of nodes;
the computer readable program code, configured to determine the rate, and policy limit to offer to the user, the user having submitted a patent application or registered patent.
the computer readable code further configured to provide a user a payout based on a pre-defined set of rules.
the computer readable code further configured to accept payment for insurance policies, and distribute a contract related to the same.

2. The network of claim 1, wherein the disturbed network is a blockchain network.

3. The network of claim 2, wherein the computer readable code is a smart contract.

4. The network of claim 1, further capable of communicating with an analysis engine.

5. The network of claim 1, wherein the policy limit and rate premium offered is varied based on an input from the user.

6. The network of claim 4, wherein the policy limit and rate premium is automatically varied based on data provided from the analysis engine.

7. The network of claim 1, further configured to communicate with the user via an online portal, the portal providing the user an option to crowdfund the patent application or registration.

8. The network of claim 1, further configured to allow the user to accept cryptocurrency from another user.

9. The analysis engine of claim 1, further configured to apply a specific pre-defined set of rules that results in identifying parts of the user patent application.

10. The analysis engine of claim 9, wherein the pre-defined set of rules relate to prior art.

11. The analysis engine of claim 9, wherein the pre-defined set of rules relate to patentability.

12. The analysis engine of claim 9, wherein the pre-defined set of rules relate to historical data for litigation.

13. The network of claim 1, further configured to provide the user to collect on an insurance policy.

14. The network of claim 1, configured to allow transactions using cryptocurrency.

15. The network of claim 1, configured to allow transactions with FIAT currency.

16. The network of claim 1, wherein the user submits a patent registration in liu of a patent application.

17. The network of claim 1, configured to allow the user to request prior art submissions.

18. The network of claim 1, further configured to allow the user to acquire funding from at least one other user for patent related activities.

19. The network of claim 1, further configured to provide an analysis report upon request from at least one other user.

20. The network claim of claim 1, further configured to allow a user to request funding from at least one other user based on the user's patent portfolio.

21. The network of claim 1, further configured to allow a user to offer ownership in a patent or patent application in exchange for funding.

22. The network of claim 1, further configured to offer the user patent backed funding.

23. The network of claim 1, further configured to offer the user litigation funding.

24. The network of claim 1, further configured to offer the user royalty base funding.
